(19) United States
(12) Patent Application Publication
(10) Pub. No.: US 2023/0117894 A1
(43) Pub. Date: Apr. 20, 2023

(54) STEAMER SYSTEM AND METHOD

(71) Applicant: Unified Brands, Inc., Vicksburg, MS (US)

(72) Inventors: Kelvin Demond Thompson, Byram, MS (US); Roger Moore, Brandon, MS (US)

(21) Appl. No.: 17/967,787

(22) Filed: Oct. 17, 2022

Related U.S. Application Data
(60) Provisional application No. 63/256,376, filed on Oct. 15, 2021.

(51) Int. Cl. A47J 27/21; F24C 7/08; A47J 27/04; A47J 36/32

(52) U.S. Cl. CPC A47J 27/21091; A47J 27/04; A47J 36/32; F24C 7/087; A47J 2027/043; A47J 2203/00

(57) ABSTRACT

The present invention provides a steamer system and method for efficiently steam cooking or heating food items and avoiding unnecessary usage stoppages or delays. The steamer system comprises an enclosed cooking space cavity, a water boiling apparatus for generating steam, a drain system, a power source, a processor, a display, and a graphical user interface accessible by a user via the display. The steamer system further comprises a series of water detection sensors positioned within the water boiling apparatus water reservoir at progressively higher points and electrically connected to the system processor. When a first water detection sensor is fouled, the system processor is configured to relinquish control to a second water detection sensor and initiate a shut down clock to allow limited continued use of the steamer before cleaning. If a third water detection sensor senses water at any time, the steamer system shuts down.

### CROSS-REFERENCE TO RELATED APPLICATIONS

This application claims priority pursuant to 35 U.S.C. 119(e) to co-pending U.S. Provisional Pat. Application Serial No. 63/256,376, filed Oct. 15, 2021, the entirety of which is incorporated herein by reference.

### FIELD OF THE INVENTION

The present invention relates generally to foodservice steamer appliances. More specifically, the present invention is concerned with foodservice steamer appliance systems and methods which integrate water level monitoring, heat control, overflow protection, and warning indicators.

### BACKGROUND OF THE INVENTION

In the foodservice industry, steamer appliances are commonly used to cook or re-thermalize various food products in large quantities using steam. For example, commercial foodservice providers frequently heat seafood, vegetables, other starches, and/or meats using commercial steamer appliances. Food steamer appliances have many advantages over alternative food heating methods, including but not limited to shorter cook times; more even heat penetration; gentler heat which does not burn or scorch food; more retained flavor, texture, moisture, and color; lower fat levels; and easier cleaning.

Currently available food steamer appliances typically include an enclosed cooking space, a water supply, a water boiling apparatus for generating steam, and a drain system, and many further include a water recirculation system. There are three main types of commercial steamer appliances: boiler-based steamers, generator-based steamers, and boilerless steamers. The primary difference between these three types of steamers is the structure of water boiling apparatus utilized, with boiler-based steamers having an attached boiler, generator-based steamers having an integrated steam generator, and boilerless steamers having a compartment within its internal cavity configured for heating water to produce steam. In addition, boilerless steamers may include connection to a water line or may be connectionless and configured for being manually filled with water.

Generally, boiler-based steamers have the fastest recovery times in between batches of food because of readily available steam in their attached boilers. Nevertheless, boiler-based steamers have the highest cost of ownership of commercial steamer appliances. Generator-based steamers typically have the next fastest recovery times and have a median cost of ownership. Boilerless steamers, although generally the slowest to recover, are the cheapest to own. Examples of currently available boilerless steamers can be found in U.S. Pat. Nos. 7,024,104 and 6,996,334, which are both owned by Unified Brands Inc. and the entireties of which are incorporated herein by reference.

While commercial steamer appliances have numerous advantages, many of which are described above, steamers are not without their disadvantages. All types of commercial steamers are prone to failures, malfunctions, and hazards resulting from regular soiling during operation and/or lack of cleaning. Extended use of steamer appliances without thorough cleaning often leads to formation and buildup of lime scale and/or food and grease over time, which can plug up drain valves and/or render water level sensors inoperable. Such plugged up drain valves and fouled water level sensors can be very hazardous to users as overflow of hot water can cause severe injuries. Additionally, these instances can contribute to unexpected equipment downtime and significant repair costs.

Most commercial steamers include a series of sensors and are programmed to trigger an emergency shutoff of the water boiling apparatus when certain conditions are met. Most commonly, steamers have two water level sensors: a low water level sensor and a high water level sensor. Such steamers are programmed to engage the heating source when the water level has reached the low water sensor level, starting production of steam. Conversely, the high water level sensor in these devices is utilized to detect when the water level is too high for safe operation of the steamer. Thus, steam production in these devices is designed to be limited to when the water level is somewhere between the low and high water level sensors. In use of such steamers, when water is detected by the high water level sensor, the system may trigger immediate shutoff of the water boiling apparatus, water drainage, and/or other safety measures. Moreover, if either of the low water level sensor or high water level sensor is fouled, the system may malfunction or shut off because of irregular sensor readings.

While safety is always of utmost importance when using steamer appliances, premature shutoffs, malfunctions, and inoperable features lead to additional issues for users. For instance, malfunction and/or shutoff could occur in the middle of cooking or reheating a batch of food or at another inopportune time, which could then result in wasted time, spoiled food, a foodservice provider having to scramble to heat food by another less desirable method, etc. What is needed is a steamer system and method which monitors and alerts a user of issues with the operability of the steamer and need for cleaning while still allowing continued usage of the steamer for a period of time while it remains safe to do so.

Heretofore, there has not been a foodservice steamer system and method with the advantages and features of the present invention.

### SUMMARY OF THE INVENTION

The present invention comprises a steamer system and method for steam cooking or re-thermalizing food items with efficiency while avoiding unnecessary usage stoppages. In an embodiment of the present invention, the steamer system includes an enclosed cooking space, a water boiling apparatus for generating steam, a drain system, a water recirculation system, a power source, a processor, a display, and a graphical user interface (GUI). In an exemplary embodiment, the steamer system display is positioned on an exterior wall of the steamer viewable and accessible from the outside and comprising a touchscreen display. The GUI of the present invention is accessible by a user via the display.

In an exemplary embodiment, the steamer system is a boilerless steamer, and the water boiling apparatus includes a watertight water reservoir and a plurality of water heating elements or gas burners for heating water within the water reservoir to a boil to produce steam.

The steamer system of the present invention is further equipped with a series of sensors positioned within the water boiling apparatus water reservoir and electrically connected to the system processor. These sensors are water detection sensors and positioned at progressively higher points within the water reservoir. In an exemplary embodiment, the steamer system includes three water detection sensors at different points within the water reservoir.

In the present invention, the positioning of the aforementioned water detection sensors accommodates a multistage steamer system and method for controlling water level and heat for steam production in the steamer. The present steamer processor is programmed to recognize the lowest water detection sensor as the primary water detection sensor for normal operational water level and heat control for the system. The system processor recognizes the second lowest water detection sensor in this embodiment as a secondary water detection sensor for use when the primary water detection sensor fails and for operation at a higher water level. The highest water detection sensor is recognized by the system as an overflow detection sensor. The overflow detection sensor is positioned at the same height or slightly below but in close proximity to the height of a mechanical overflow housing within the water reservoir.

In operation of an embodiment of the steamer system of the present invention, the water level within the water boiling apparatus water reservoir is filled to a point above the primary water detection sensor but below the secondary water detection sensor. The system fills water until the primary water detection sensor senses water. The water boiling apparatus is then turned on to create steam, and the steamer is used to cook or heat food items as normal. In the event the primary water detection sensor is fouled, such that the primary water detection sensor does not sense water but the secondary water detection sensor does detect water (once the water rises to or above the level of the secondary water detection sensor), the processor of the present system is programmed to relinquish water sensing control to the secondary water detection sensor.

Once the secondary water detection sensor assumes control, a visual and/or audible cleaning warning is triggered which is viewable on the display screen and/or which sounds via a display speaker. In the same instance, a shutdown clock is displayed and a countdown initiated on the display screen, which provides a user the opportunity to complete a cooking cycle or create a plan for continued use of the steamer until the shutdown clock expires. In an exemplary embodiment, the appearance and parameters of the shutdown clock are customizable by a user using the GUI and display.

Upon activation of the secondary water detection sensor, the water level within the water boiling apparatus is raised to above the secondary water detection sensor but below the overflow level. At that point the steamer continues to operate until the shutdown clock expires, or the secondary water detection sensor fouls such that the water level reaches the overflow water detection sensor without triggering the secondary water detection sensor, whichever comes first.

If at any time the overflow water detection sensor detects water, the steamer appliance is configured to immediately turn off the heat source and drain water from the water boiling apparatus to prevent hot water from overflowing out of the appliance. This provides an additional level of protection from hazards associated with hot fluids exiting the steamer appliance when opening it.

The logic and sensing device arrangement of the present invention provides a visual and/or audible indicator that gives the user of the appliance advanced notification that cleaning is necessary before more critical failure occurs while still allowing the appliance to continue to operate for a period of time. This continued operational period is indicated by the visual countdown clock on the display screen before the appliance automatically shuts down. The present invention provides the opportunity to plan and complete cooking cycles while assisting the user with awareness of when the appliance will require cleaning. This reduces the amount downtime due to unforeseen failure because of lack of cleaning water sensing devices, creating greater efficiency in the foodservice industry.

In further aspects of the present invention, the steamer system includes a steam lid for separating the cook space from the water boiling apparatus. Preferably, the steam lid is shaped in a way to direct condensate into a separate condensate drain.

In a preferred embodiment, the steamer system is further configured to conduct a sensor function check and display any associated warnings upon initial powering up of the steamer appliance. Additionally, embodiments of the present invention integrate primary and secondary overflows, water flow restriction, and/or maximum water flow time.

The foregoing and other objects are intended to be illustrative of the invention and are not meant in a limiting sense. Many possible embodiments of the invention may be made and will be readily evident upon a study of the following specification and accompanying drawings comprising a part thereof. Various features and subcombinations of invention may be employed without reference to other features and subcombinations. Other objects and advantages of this invention will become apparent from the following description taken in connection with the accompanying drawings, wherein is set forth by way of illustration and example, an embodiment of this invention and various features thereof.

### BRIEF DESCRIPTION OF THE DRAWINGS

Embodiments of the present invention are described in detail below with reference to the attached drawing figures, wherein:

FIG. 1 is an upper, right, perspective view of a steamer appliance embodying the present invention.

FIG. 2 is a front, elevational view of the steamer appliance.

FIG. 3 is a back, elevational view of the steamer appliance.

FIG. 4 is a left, side, elevational view of the steamer appliance.

FIG. 5 is a right, side, elevational view of the steamer appliance.

FIG. 6 is a top, plan view of the steamer appliance.

FIG. 7 is a bottom, plan view of the steamer appliance.

FIG. 8 is an upper, right, perspective view of an inner cavity of the steamer appliance, further illustrating internal components of the steamer appliance.

FIG. 9 is an upper, left, perspective view of the inner cavity of the steamer appliance.

FIG. 10 is a front, elevational view of the inner cavity of the steamer appliance.

FIG. 11 is a left, side, elevational view of the inner cavity of the steamer appliance.

FIG. 12 is a right, side, elevational view of the inner cavity of the steamer appliance.

FIG. 13 is an upper, perspective view of a portion of the water boiling apparatus of a steamer appliance of the present invention.

FIG. 14 is an upper, enlarged, perspective view of a portion of the water boiling apparatus of the steamer appliance, with the primary water detection sensor, secondary water detection sensor, overflow water detection sensor, and a steam lid support member shown.

FIG. 15 is an upper, enlarged, perspective view of a portion of the water boiling apparatus of the steamer appliance, with the primary water detection sensor, secondary water detection sensor, overflow water detection sensor, condensate drain, and a steam lid support member shown.

FIG. 16 is an upper, perspective view of the inside of cooking space of the steamer apparatus.

The drawing figures do not limit the present invention to the specific embodiments disclosed and described herein. The drawings are not necessarily to scale, emphasis instead being placed upon illustrating the principles of the invention.

### DETAILED DESCRIPTION OF THE PREFERRED EMBODIMENTS

As required, a detailed embodiment of the present invention is disclosed herein; however, it is to be understood that the disclosed embodiments are merely exemplary of the principles of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

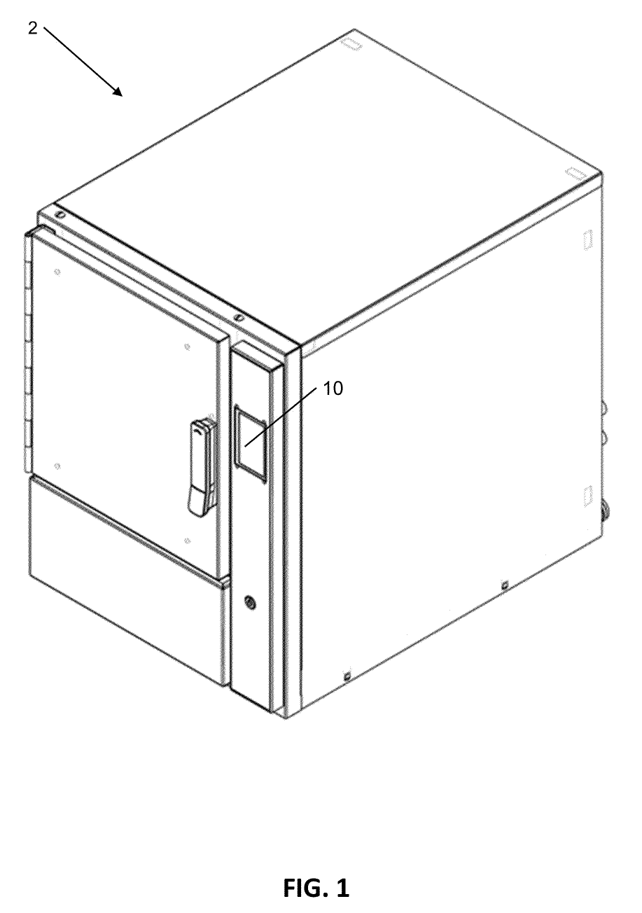

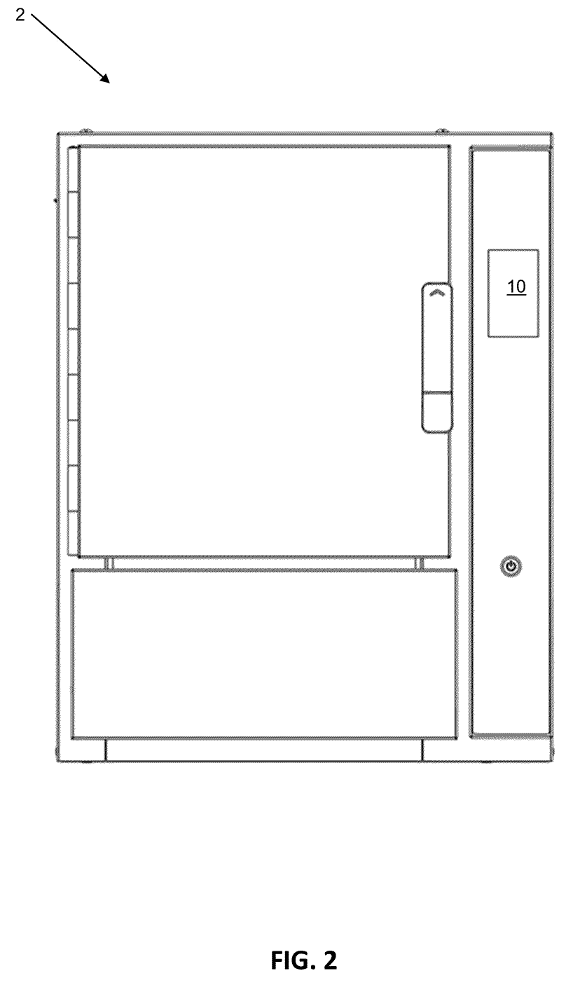

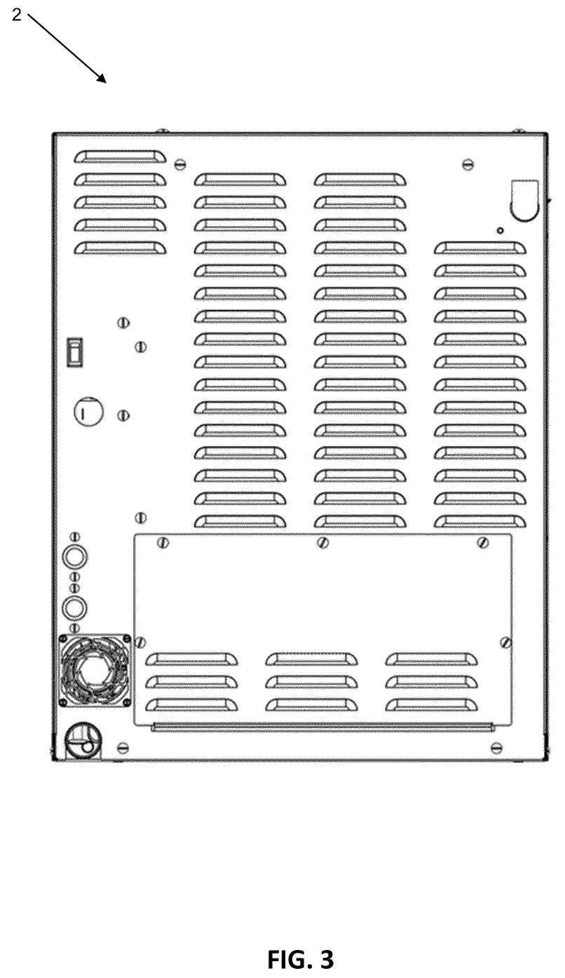

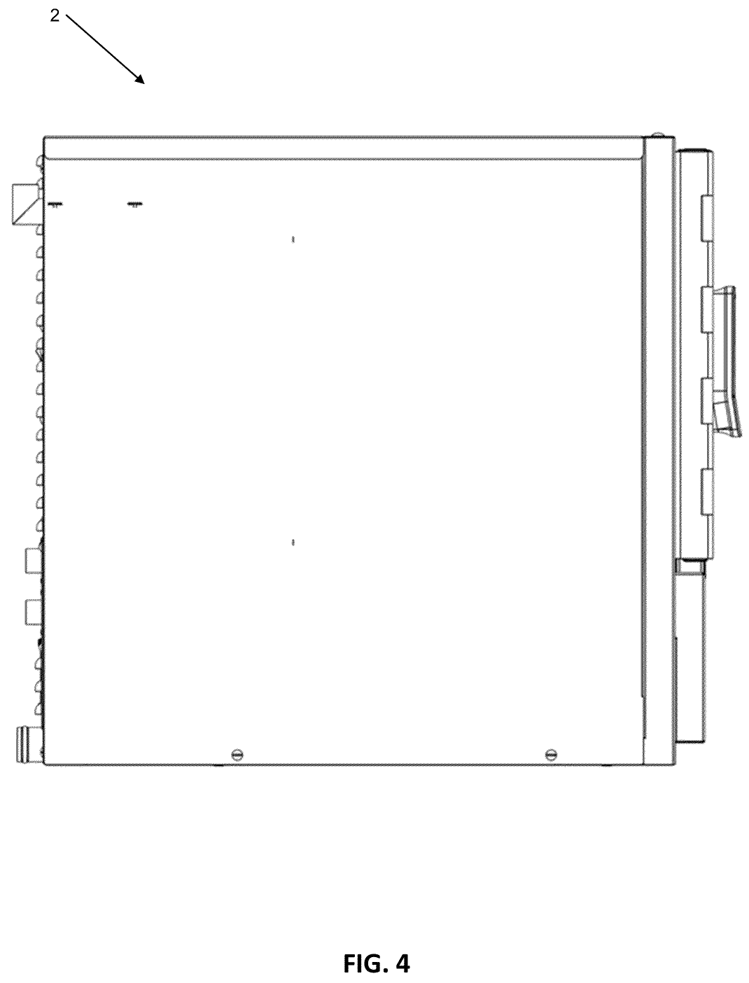

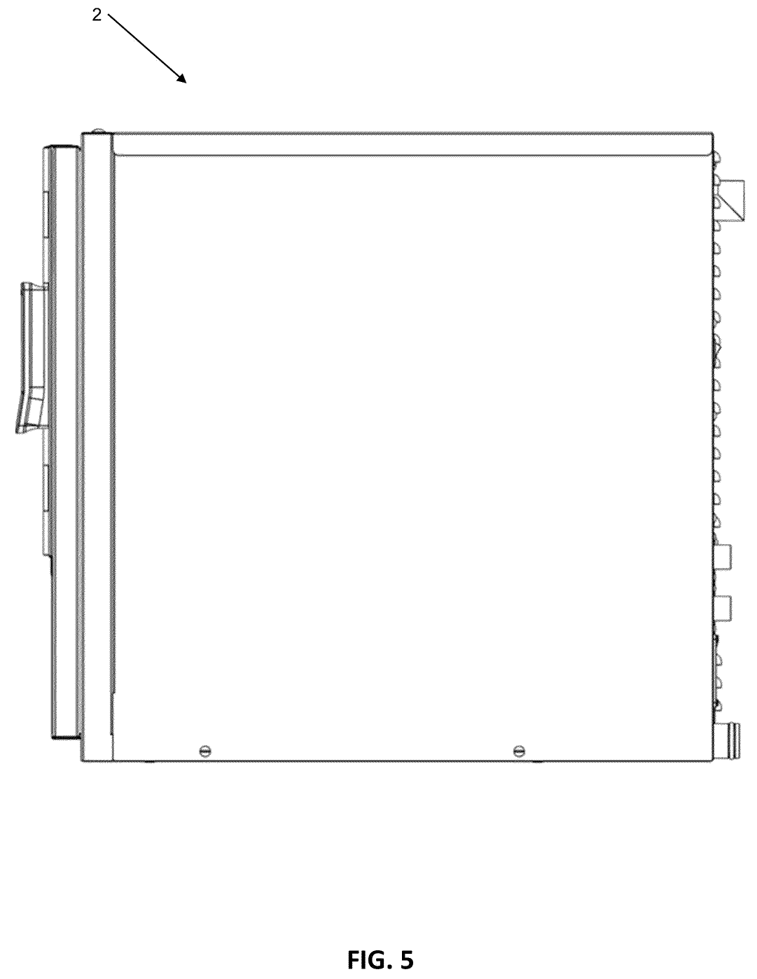

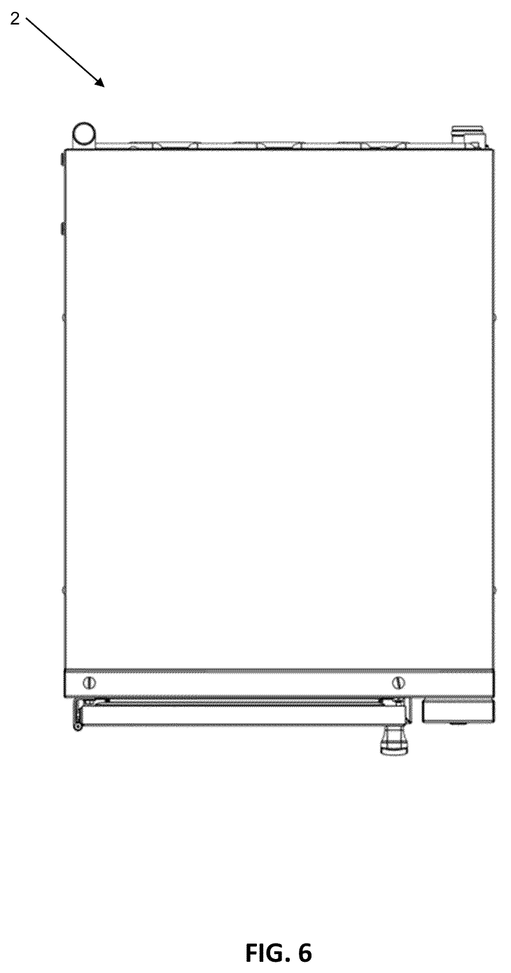

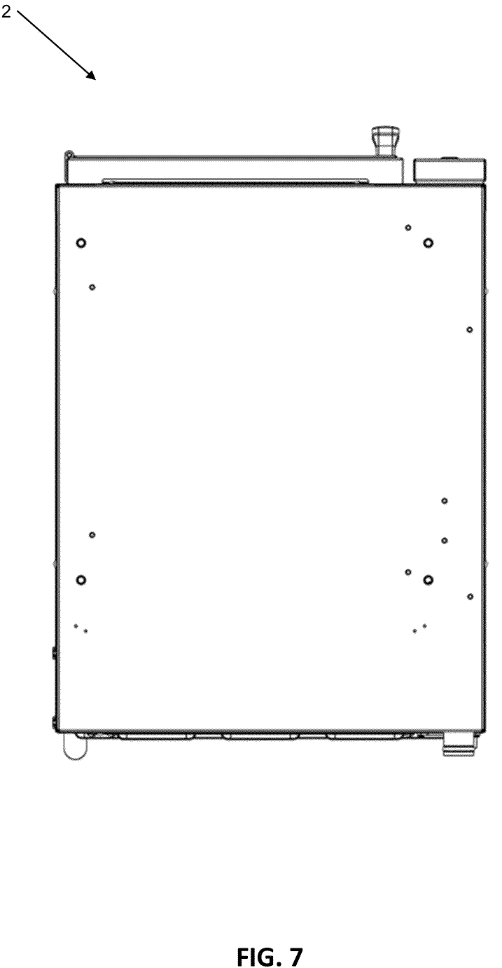

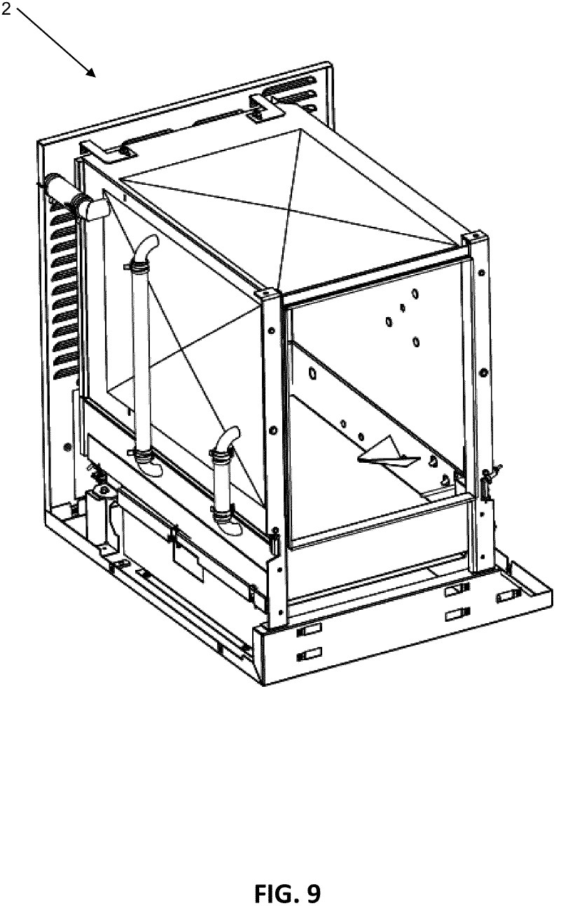

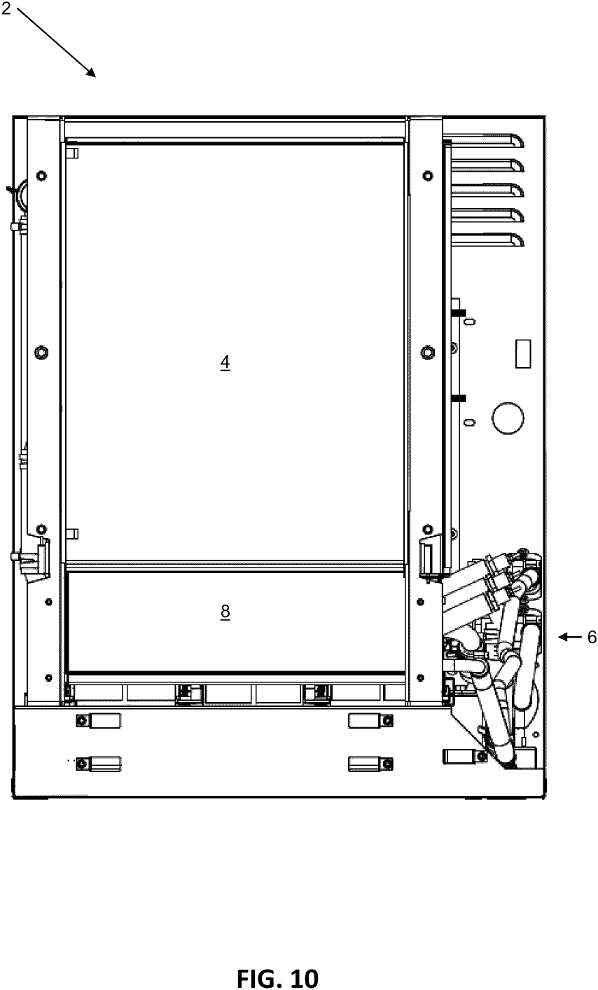

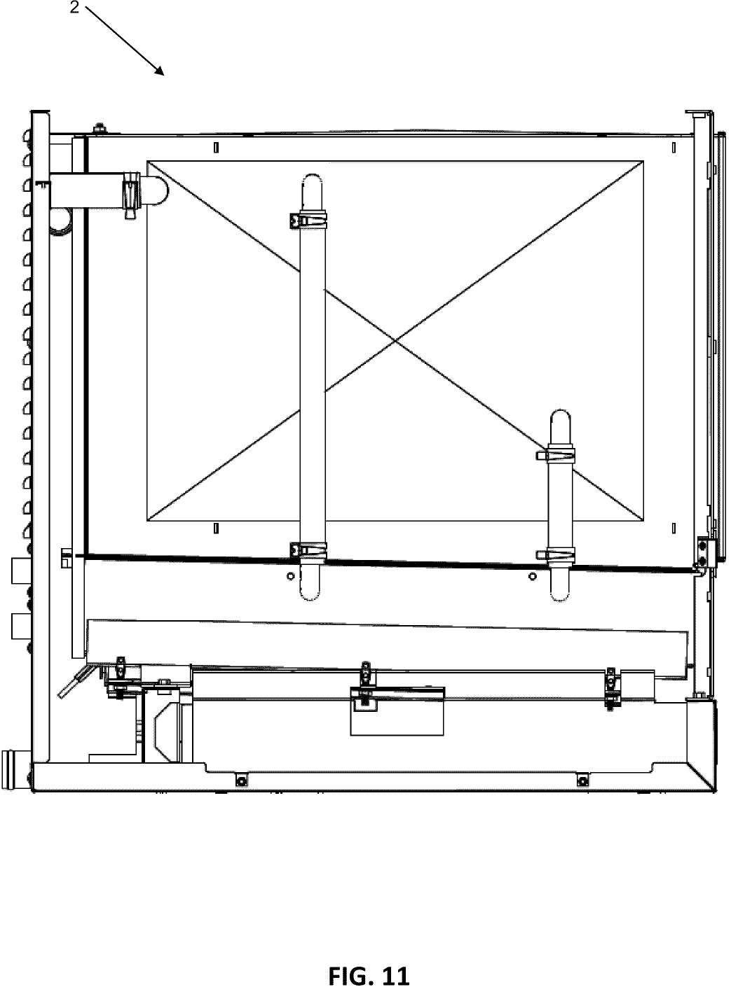

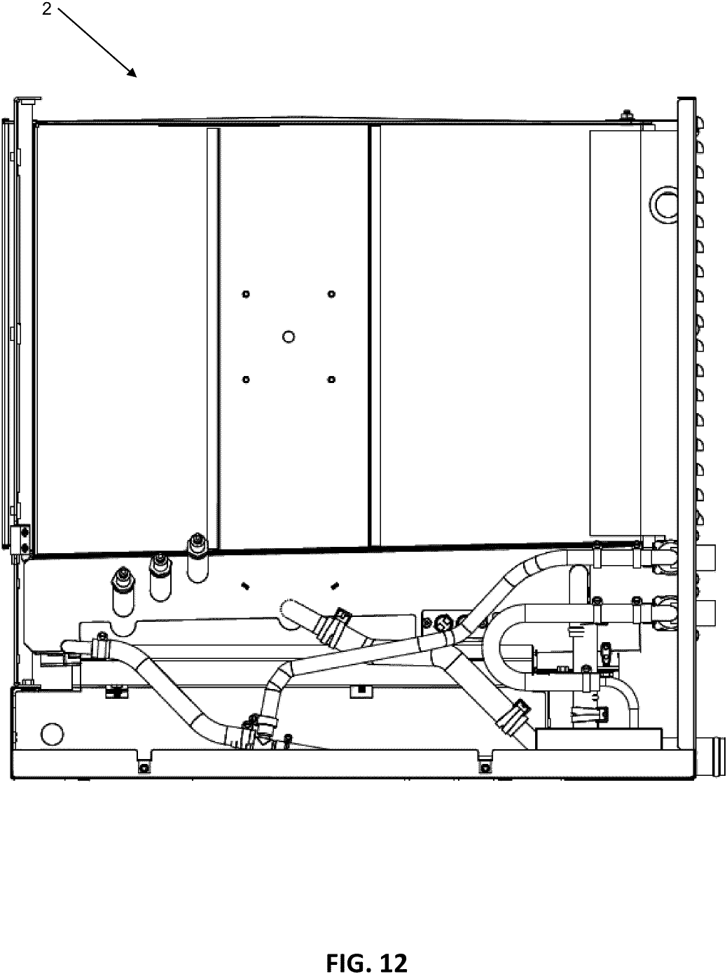

The present invention comprises a steamer system and method for efficiently steam cooking or re-thermalizing food items and avoiding unnecessary usage stoppages or delays. Referring to the drawings in more detail, FIGS. 1-16 show an exemplary embodiment of a steamer system 2 of the present invention. In this embodiment, the steamer system 2 comprises an enclosed cooking space cavity 4, a water boiling apparatus 6 for generating steam, a drain system, a power source, a processor, and a display 10. In an exemplary embodiment, the present system further comprises a graphical user interface (GUI) accessible by a user via the display 10. In an exemplary embodiment, the steamer system 2 also includes a water recirculation system for retaining water within the system.

In an exemplary embodiment, the steamer system display 10 is positioned on an exterior wall of the steamer viewable and accessible from the outside and comprising a touchscreen display. Nevertheless, in alternative embodiments, the display is a standard light-emitting diode (LED), liquid crystal display (LCD), or similar display screen with associated push buttons. In further embodiments, the display is positioned in an alternative location than on an exterior wall of the steamer. In some embodiments, the display is positioned on an internal surface of the steamer. In embodiments, the display and/or a secondary display are accessible on a remote computing device, such as but not limited to a computer or smart device. In such embodiments, the remote computing device communicates with the steamer system via internet, intranet, or other radio frequency communication. The display in some embodiments does, and in other embodiments does not, also include an integrated speaker system for audible warning and/or button activating sounds. In an exemplary embodiment, a user can utilize the GUI and provide input to the system via touchscreen or push buttons associated with the display.

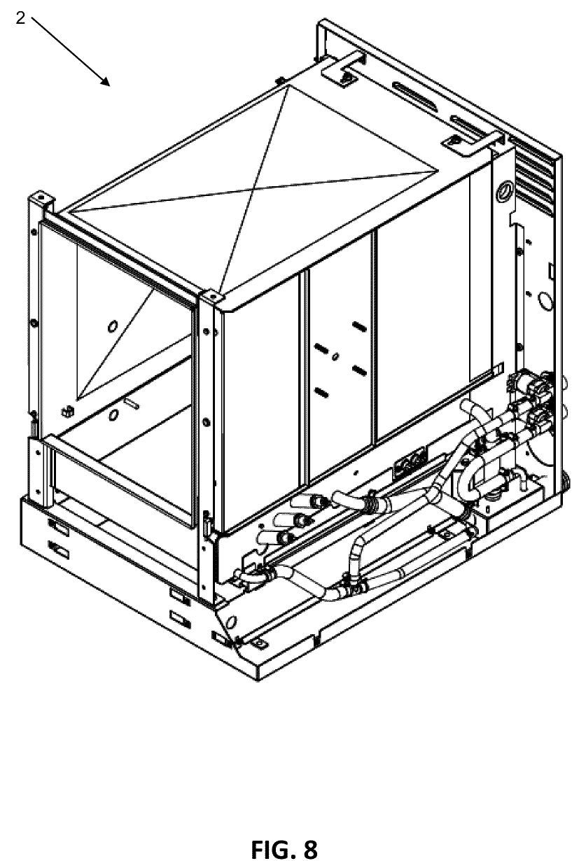

FIGS. 1-7 show alternative views of the outer appearance of a steamer system 2 embodying the present invention, including a display 10 on the exterior, front wall of the steamer. FIGS. 8-12 show alternative views of the inner cavity portion of the steamer system 2 which encompasses the cooking space 4, water boiling apparatus 6, sensing components, water draining components, and internal electrical connections, among other internal features described herein and illustrated therein.

In an exemplary embodiment, the steamer system 2 is a boilerless steamer, and the water boiling apparatus 6 includes a watertight water reservoir 8 and a plurality of water heating elements or gas burners for heating water within the water reservoir 8 to a boil to produce steam. Nevertheless, the present invention in other embodiments is also configured for any other type of steamer appliance, including but not limited to generator-based steamer embodiments and boiler-based steamer embodiments.

The steamer system 2 of the present invention is further equipped with a series of sensors positioned within the water boiling apparatus water reservoir 8 and electrically connected to the system processor. These sensors are water detection sensors 12, 14, 16 which are positioned at progressively higher points within the water reservoir. The water detection sensors in various embodiments include but are not limited to conductivity sensors, float sensors, capacitive sensors, any other type of water detection sensor, or combinations thereof. In a preferred embodiment, the steamer system includes three water detection sensors at different points within the water reservoir. Nevertheless, the present system is intended to be scalable with any number of sensors utilized. In embodiments, the steamer system includes two, three, four, five, six, seven, or eight water detection sensors.

In the present invention, the positioning of water detection sensors 12, 14, 16 provides a multistage steamer system 2 and method for controlling water level and heat for steam production in the steamer. The present steamer processor is programmed to recognize the lowest water detection sensor 12 as the primary water detection sensor for normal operational water level and heat control for the system. The system processor recognizes the second lowest water detection sensor 14 in this embodiment as a secondary water detection sensor for use when the primary water detection sensor fails and for operation at a higher water level. The highest water detection sensor 16 is recognized by the system as an overflow detection sensor. The overflow detection sensor 16 is positioned at the same height or slightly below but in close proximity to the height of a mechanical overflow housing 18 within the water reservoir 8, which in various embodiments includes a tube, pipe, enclosure, drain, or other housing for receiving overflow water from the water boiling apparatus. In some embodiments of the present invention, the overflow detection sensor 16 is positioned away from the mechanical overflow housing 18 or mounted or attached to mechanical overflow housing.

In embodiments of the present invention, the steamer system includes a steam lid 28 for separating the cook space 4 from the water boiling apparatus 6. Preferably, the steam lid 28 is shaped in a way to direct or funnel condensate into a separate condensate drain 34.

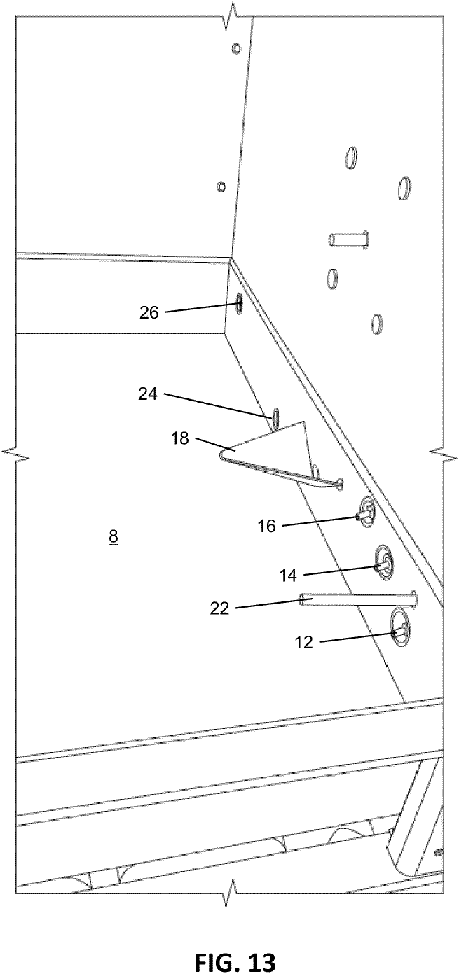

FIG. 13 shows a portion of the water boiling apparatus 6 of a steamer appliance 2 of the present invention, with the primary water detection sensor 12, secondary water detection sensor 14, overflow water detection sensor 16, overflow housing and condensate drain 18, overflow drain 20, and a steam lid support member 22 shown.

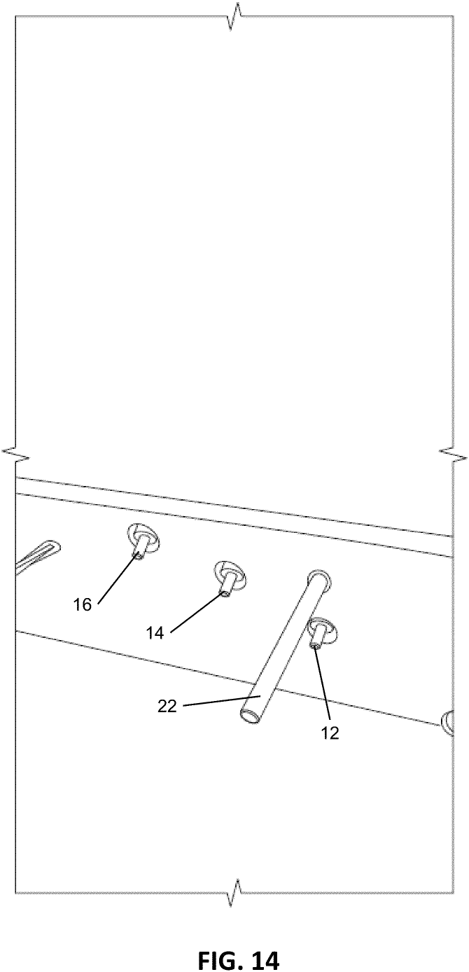

FIG. 14 shows a portion of the water boiling apparatus 6 of the steamer appliance 2, with the primary water detection sensor 12, secondary water detection sensor 14, overflow water detection sensor 16, and a steam lid support member 22 shown.

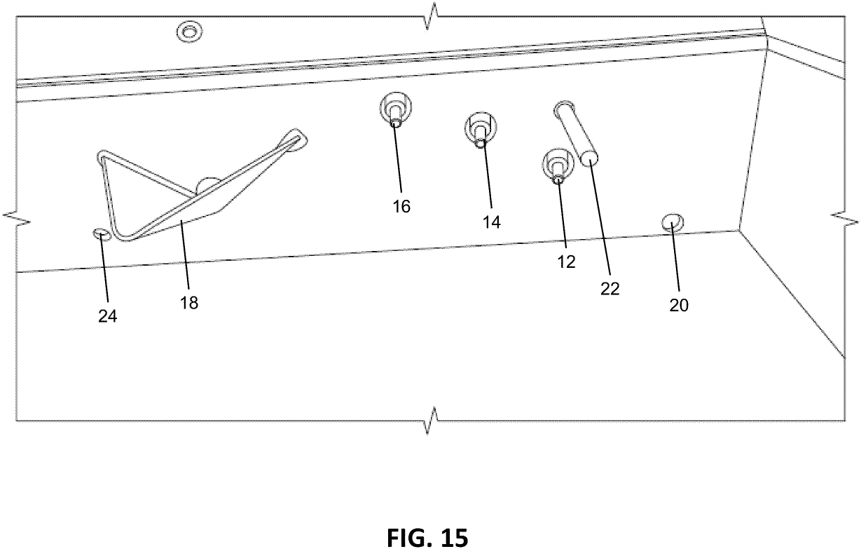

FIG. 15 shows a portion of the water boiling apparatus 6 of the steamer appliance 2, with the water inlet 24, reservoir drain 20, primary water detection sensor 12, secondary water detection sensor 14, overflow water detection sensor 16, condensate drain 18, and a steam lid support member 22 shown.

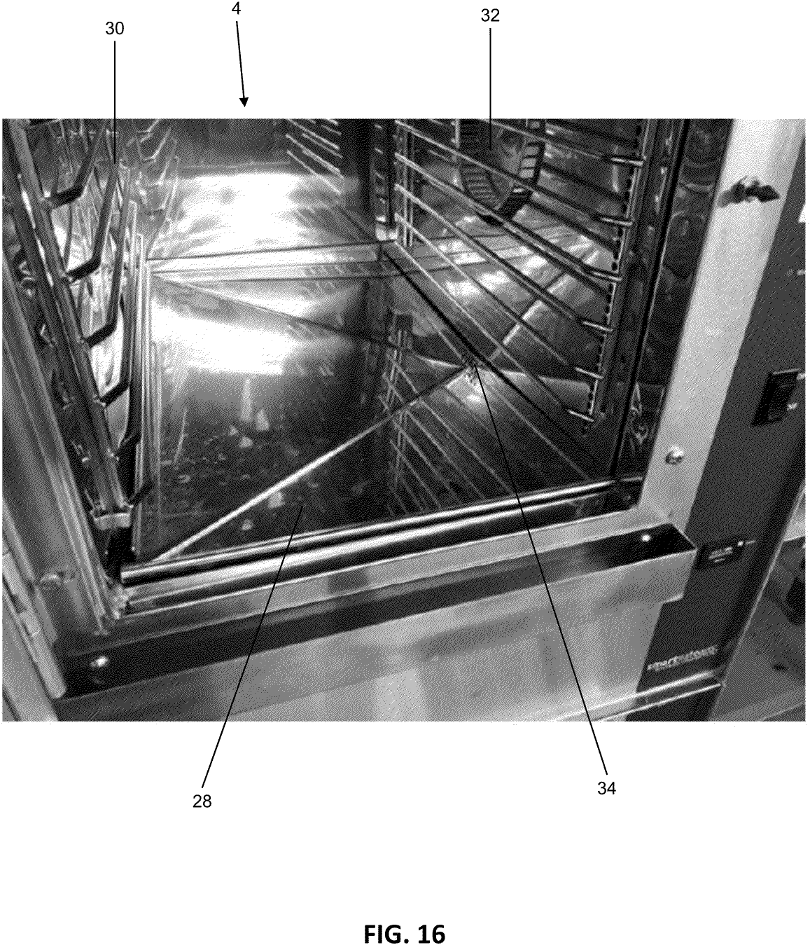

FIG. 16 shows the inside of the steamer apparatus 2, with the cooking space 4, steam lid 28, food tray racks 30, and convection fan 32 shown.

In an exemplary embodiment, the steamer system 2 includes attachment to a water line which is fluidically connected to a water inlet into the water reservoir of the water boiling apparatus. In alternative embodiments, the water reservoir may be filled manually. In other embodiments, the steamer system further comprises a fillable water holding tank fluidically connected to a water inlet into the water reservoir of the water boiling apparatus. In embodiments, the water inlet is electrically connected to and controlled by the system processor. In embodiments, the water reservoir drain(s) are electrically connected to and controlled by the system processor.

In embodiments, the steamer system 2 further includes a steam delivery system, a convection fan 32, steam lid support members 22 for mounting the steam lid, and food tray racks 30 for mounting food trays. The system may further include temperature sensor(s), pressure sensor(s), or any other type of relevant sensor. In embodiments, the system includes additional fans for increasing efficiency and/or preventing processor overheating.

In an exemplary embodiment, the steamer system 2 is further configured to conduct a sensor function check and to display any associated warnings upon initial powering up of the steamer appliance. Additionally, the present invention may integrate primary and secondary overflows, water flow restriction, and maximum water flow time.

In operation of an exemplary embodiment of the steamer system 2 of the present invention, the water level within the water boiling apparatus water reservoir 8 is filled to a point above the primary water detection sensor 12 but below the secondary water detection sensor 14. The system fills water until the primary water detection sensor 12 senses water. The water boiling apparatus 6 is then turned on to create steam, and the steamer 2 is used to cook or heat food items as normal. In the event the primary water detection sensor 12 is fouled, such that the primary water detection sensor 12 does not sense water, the processor of the present system is programmed to relinquish water sensing control to the secondary water detection sensor 14.

Once the secondary water detection sensor 14 assumes control, a visual and/or audible cleaning warning is triggered which is viewable on the display screen 10 and/or which sounds via a display speaker. In the same instance, a shutdown clock will be displayed and a countdown initiated on the display screen 10, which provides a user the opportunity to complete a cooking cycle or create a plan for continued use of the steamer 2 until the shutdown clock expires. In an exemplary embodiment, the appearance and parameters of the shutdown clock, including but not limited to the amount of time before the system shuts down, are customizable by a user using the GUI and display.

Upon activation of the secondary water detection sensor 14, the water level within the water boiling apparatus 6 is raised to a level at or above the level of the secondary water detection sensor 14 but below the overflow level 16. At that point the steamer 2 is configured to continue to operate until the shutdown clock expires, or the secondary water detection sensor 14 fouls such that the water level reaches the overflow water detection sensor 16 without triggering the secondary water detection sensor 14, whichever comes first.

In an exemplary embodiment, if at any time the overflow water detection sensor 16 detects water, the steamer appliance 2 is configured to immediately turn off the heat source and drain water from the water boiling apparatus 6 to prevent hot water from overflowing out of the appliance. This provides an additional level of protection from hazards associated with hot fluids exiting the steamer appliance when opening it.

The logic and sensing device arrangement of the present invention provides a visual and/or audible indicator that gives the user of the appliance advanced notification that cleaning is necessary before more critical failure occurs while still allowing the appliance to continue to operate for a customizable period of time. This continued operational period is indicated by the visual countdown clock on the display screen before the appliance automatically shuts down. The present system and method provide the opportunity to plan and complete cooking cycles while assisting the user with awareness of when the appliance will require cleaning. This reduces the amount downtime due to unforeseen failure because of a lack of cleaning water sensing devices, creating greater efficiency in the foodservice industry.

In an exemplary embodiment of the present invention, when the system power unit is plugged in and the power button is activated, startup screens appear on the display, and unit proceeds through startup diagnostics. In a preferred embodiment, a linear progress bar animation is displayed during startup.

In an exemplary embodiment, the system processor is configured for performing a self-diagnosis test during startup. If the low or high probe is not functioning during a startup self-diagnosis test, the unit will drain empty and a popup window will display instructing the user to clean critical areas before restarting. In an exemplary embodiment, the unit is programmed to always conduct a break/make/break check at the low water probe before beginning startup if the water level at the starting condition is at or above low probe.

In an embodiment, a delime button is available only during start up and if the delime button is on in a settings menu. When such setting is on, all popups related to cleaning reference delime and a manual cleaning process. When the delime button is off in settings, a delime reminder is unavailable, and all popups related to cleaning reference the manual cleaning process only.

Pressing the delime button enters control into delime mode and shows a first delime screen. Regardless of when during startup the delime button is pushed, the unit fills to the high probe checking make/break/make transition. If the high probe is functioning, a probe based delime cycle is initiated. If the high probe is not functioning, the unit will drain empty, and a popup will display to clean all probes before restating the delime process. If the high probe continues not to function, the unit will continue to repeat the popup for cleaning before restart until the high probe issue is resolved. Startup diagnostics begin after the delime process is complete and unit is restarted.

In an embodiment, a shutdown screen appears when the power switch is turned off. In an exemplary embodiment, the unit performs another self-diagnosis of the low and high probes before turning off. In an embodiment, the muffin fan stays on until the display screen is blank. In an embodiment, the convection fan and heating contactor goes off as soon as the shutdown process begins. In an embodiment, power cycling during shutdown causes the unit to drain to the low probe and begin startup procedure. If the front on/off button is pressed or an error caused shutdown occurs and both probes are functioning, then the unit will fill to the high probe; drain to the low probe for a set number of minutes; refill to the High probe; and then drain cavity to empty. If the front on/off button is pressed or the shutdown counter expires and the high probe is functioning and the low probe is not functioning, then the unit will drain for a set number of minutes; then fill to the high probe and drain for a set number of minutes; then fill to the high probe and drain the cavity to empty. If the front on/off button is pressed or the shutdown counter expires and the low probe is functioning and the high probe is not functioning, then the unit will drain off the low probe a set number of seconds or minutes; then fill past the low probe for a set number of minutes; and drain the cavity to empty. If an error shutdown occurs and the low and high probes are not functioning, then the unit will attempt to fill for a set number of minutes and then drain cavity to empty. All active audible alarms are disabled when the on/off button is pressed to turn off unit. Once the power button is pressed or the shutdown process is initiated to turn the unit off, the power button is disabled to turn the unit back on until the shutdown process is complete.

In an exemplary embodiment, once diagnostics are complete, the unit begins to heat. In an embodiment, a progress bar has three steps: first step (33% fill) indicates heating has started; second step (66% fill) indicates a “hold” temperature has been reached; and third step (100% fill) indicates a ready temperature has been reached. In an embodiment, when a ready temperature is reached, the unit display transitions to a manual cook screen, a ready light illuminates, and one 3 second beep sounds. Condensate spray remains off until the ready temperature is reached (Ready tstat opens).

If the low probe has failed and the high probe is detected, a shutdown clock appears on the display with a countdown. In an exemplary embodiment, once trigged, the shutdown clock will be displayed on all screens until the countdown time expires, at which time the unit automatically shuts down. In an exemplary embodiment, when the shutdown clock counts down to 1 hour, a popup appears on the display and/or an alarm sounds until cleared by a user pressing an OK button. In an embodiment, the shutdown clock at the top of the screen starts flashing in red text from one hour (or alternative countdown time) until it reaches 0:00.

In an exemplary embodiment, the total run time is recorded from the moment the power switch is toggled on and the circuit latches.

In an exemplary embodiment, a user can customize system settings. In an embodiment, customizable settings include time display format (e.g., 12 hr, 24 hr); date; language; temperature scale (e.g., F, C); door alarm settings (e.g., off, 2 min, 5 min, 10 min); button sounds; display brightness; number of timers; timer screen lock (on, off); and alarm volume.

In an embodiment, the system includes a unit status list and a diagnostics list viewable via the display. In embodiments, the unit status list and/or diagnostics list include some or all of the following: board communication (active/lost), circulation fan (on/off), fill valve (on/off), drain valve (on/off), condensate valve (on/off), cooling fan (on/off), water level low (open/closed), water level high (open/closed), water level overflow (open/closed), door switch (open/closed), high limit thermostat, ready thermostat, hold thermostat, condensate thermostat, board temperature, control voltage, and contactor.

In an exemplary embodiment, a manual mode of the system requires all safeties to be active to prevent overheating, overfilling, etc.

In an embodiment, the system includes a USB port and allows for data transfer between an inserted USB drive. In an embodiment, data automatically downloads upon USB insertion if the USB drive is functional. If USB drive is already inserted, the process begins immediately after a data retrieval button is pushed.

In an exemplary embodiment, prior to and after pressing a start button, the reservoir continues to fill and probe tests are performed. If the high probe is functioning, a probe based delime cycle is initiated. If the high probe is not functioning, the unit drains empty, and a popup displays a message to clean all probes before restarting the delime process. If the high probe continues not to function, the unit will continue to repeat the popup for cleaning before restart until the high probe issue is resolved. After filling is compete, delimer is to be added by the operator. Pressing a continue button and shutting the door starts a delime cycle.

In an embodiment, before entering the timed cook screen, the user sets the time for steaming. In an exemplary embodiment, a countdown timer displays countdown time in a H:MM:SS format. Nevertheless, in other embodiments the countdown time is shown in other formats. In an exemplary embodiment, text on the display is sized to fit the display screen and to enlarge when time is less than 60 minutes. In an embodiment, when the door is open, seconds will stop counting down and the timer is paused while the door is open (nevertheless, such function depends on a compensating timer setting).

In an exemplary embodiment, if a timed cook expires when a menu or other screen is open, the control will sound an alarm but will allow the user to continue activity.

In an exemplary embodiment, a hold mode of the present invention maintains a cavity temperature of 140-165° F. When “HOLD” is initiated and if HOLD & READY thermostats are closed then heat turns on. Heat remains on until the HOLD & READY thermostat opens. When the READY thermostat opens, the heat turns off. Heat remains off until the READY thermostat closes. Then, the heat on/off cycle rate initiates. If the HOLD thermostat closes due to drop in temperature, and the READY thermostat is still closed, then the heat turns on and repeats the sequence. If the HOLD thermostat is open and the READY thermostat is closed then the heat turns on when “HOLD” is initiated. The heat remains on until the READY thermostat opens. When the READY thermostat opens, the heat turns off. The heat will remain off until the READY thermostat closes, and then the heat on/off cycle rate will initiate. If the HOLD thermostat closes due to a drop in temperature, and the READY thermostat is still closed, then the heat turns on and repeats the sequence. When “HOLD” is initiated and the HOLD & READY thermostats are open, then the heat will turn off. Heat will remain off until the READY thermostat closes. Heat will remain off until the READY thermostat closes, and then the heat on/off cycle rate will initiate. If the HOLD thermostat closes due to a drop in temperature, and the READY thermostat is still closed, then the heat turns on and repeats the sequence. When unit is in hold mode, the fan is off unless the unit is cycling on the heating algorithm.

In an exemplary embodiment, if a timer goes off while on the home screen or a non-cook screen, a popup will appear as an acknowledged alert. Pushing an OK button will silence the alarm and close the popup. In an embodiment, if multiple timers are expiring, each subsequent timer silences the previous one, and only the last timer is shown. In a preferred embodiment, a popup will show the number of the expiring timer plus any saved timer name.

In an exemplary embodiment, if a pan timer is set for longer than an active cook time, a pop-up warning appears when such timer has started. In an embodiment, a popup occurs when a timer is activated and/or started in hold mode.

In an exemplary embodiment, when a fatal error occurs, a popup is displayed, and an alarm tone sounds, such as but not limited to a continuous beep for 10 seconds, repeating every 60 seconds. In an exemplary embodiment, if multiple errors occur, only the last error is displayed. In an embodiment, all errors are recorded in an error log along with the status of each component. Upon fatal error, the unit immediately enters into a shutdown process (to be defined for each type of fatal error), but preferably, the error remains on the screen until the power button is switched off. If errors still exist at start up, the unit will re-alarm. In an embodiment, a “silence alarm” button stops the audible alarm but leaves the popup on the display screen. If the service mode is entered at start up after a fatal error, the unit will go to the service mode screen and allow service functions to be performed. Certain fatal errors may still allow for a user to perform a limited action, such as but not limited to deliming the unit.

In an exemplary embodiment, during cook, hold, and delime modes, leaving the steamer door open for longer than 2 minutes (or alternative timeframe) results in a popup message and a continuous tone alarm sounding. Such popup will go away and such alarm will silence by pressing the OK button or by shutting the door. The counter will start again after pressing the OK button or closing the door. Preferably, such open time parameter is settable in settings (e.g., off, 2 min, 5 min, 10 min).

In an exemplary embodiment, if the low probe stops functioning during timed, manual, or hold mode, a non-fatal error popup is displayed and an alarm tone sounds (such as but not limited to a continuous beep for 10 seconds, repeating every 60 seconds) along with a shutdown clock that counts down from a preset amount of time. In an exemplary embodiment, the popup reoccurs when one hour is left on the shutdown clock. In an embodiment, the shutdown clock is displayed on all screens after occurrence until the countdown time expires or the power button is pressed to turn the unit off. In an embodiment, if the probe error reoccurs after a power cycle, a popup displays.

Certain terminology is used in the description for convenience in reference only and will not be limiting. For example, up, down, front, back, right, and left refer to the invention as orientated in the view being referred to. The words “inwardly” and “outwardly” refer to directions toward and away from, respectively, the geometric center of the aspect being described and designated parts thereof. Forwardly and rearwardly are generally in reference to the direction of travel, if appropriate. Additionally, anatomical terms are given their usual meanings. For example, proximal means closer to the trunk of the body, and distal means further from the trunk of the body. Said terminology shall include the words specifically mentioned, derivatives thereof, and words of similar meaning.

As used in this specification and the appended claims, the singular forms “a”, “an”, and “the” include plural references unless the context clearly dictates otherwise. Thus, for example, a reference to “a method” includes one or more methods, elements, and/or steps of the type described herein and/or which will become apparent to those persons skilled in the art upon reading this disclosure and so forth.

As used in this specification and the appended claims, the use of the term “about” means a range of values including and within 15% above and below the named value, except for nominal temperature. For example, the phrase “about 3 mM” means within 15% of 3 mM, or 2.55 - 3.45, inclusive. Likewise, the phrase “about 3 millimeters (mm)” means 2.55 mm - 3.45 mm, inclusive. When temperature is used to denote change, the term “about” means a range of values including and within 15% above and below the named value. For example, “about 5° C.,” when used to denote a change such as in “a thermal resolution of better than 5° C. across 3 mm,” means within 15% of 5° C., or 4.25° C. - 5.75° C. When referring to nominal temperature, such as “about -50° C. to about +50° C.,” the term “about” means ± 5° C. Thus, for example, the phrase “about 37° C.” means 32° C. - 42° C.

Unless defined otherwise, all technical and scientific terms used herein have the same meaning as commonly understood by one of ordinary skill in the art to which this invention belongs. Although any systems, elements, methods and materials similar or equivalent to those described herein can be used in the practice or testing of the present invention, the preferred systems, elements, and methods and materials are now described. All publications mentioned herein are incorporated herein by reference to describe in their entirety.

“Substantially,” “approximately,” and similar terms of degree mean more-or-less conforming to the particular dimension, range, shape, concept, or other aspect modified by the term, such that a feature or component need not conform exactly. For example, a “substantially cylindrical” object means that the object resembles a cylinder but may have one or more deviations from a true cylinder. “Comprising,” “including,” and “having” (and conjugations thereof) are used interchangeably to mean including but not necessarily limited to, and are openended terms not intended to exclude additional, unrecited elements or method steps.

Changes may be made in the above methods, devices and structures without departing from the scope hereof. Many different arrangements of the various components depicted, as well as components not shown, are possible without departing from the spirit and scope of the present invention. Embodiments of the present invention have been described with the intent to be illustrative and exemplary of the invention, rather than restrictive or limiting of the scope thereof. Alternative embodiments will become apparent to those skilled in the art that do not depart from its scope. Specific structural and functional details disclosed herein are not to be interpreted as limiting, but merely as a representative basis for teaching one of skill in the art to employ the present invention in any appropriately detailed structure. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

It is also to be understood that the following claims are intended to cover all of the generic and specific features of the invention herein described, and all statements of the scope of the invention which, as a matter of language, might be said to fall therebetween.

1. A steamer system comprising:
a cooking space;
a water boiling apparatus fluidically connected to said cooking space and electrically connected to a processor and a power source;
said water boiling apparatus defining a water reservoir;
a water inlet valve into said water reservoir fluidically connected to a water source and electrically connected to said processor;
said water boiling apparatus comprising a heater electrically connected to said processor and configured for heating water in said water reservoir to a boil;
said water boiling apparatus comprising a first water detection sensor positioned within said water reservoir and electrically connected to said processor and a second water detection sensor positioned higher within said water reservoir than said first water detection sensor and electrically connected to said processor;
a drain system fluidically connected to said water reservoir and electrically connected to said processor; and
a display electrically connected to said processor;
wherein said water boiling apparatus is configured for providing steam to said cooking space when said water reservoir is filled with water and said heater heats water in said water reservoir to a boil.

2. The steamer system of claim 1, wherein:
said processor is configured for assigning primary water detection control to said first water detection sensor until said first water detection sensor is fouled; and
said processor is configured for relinquishing said primary water detection control from said first water detection sensor and assigning said primary water detection control to said second water detection sensor when said first water detection sensor is fouled until said second water detection sensor is fouled.

3. The steamer system of claim 2, wherein:
said steamer system is configured for increasing water level within said water reservoir to a level at or higher than the position of said second water detection sensor when said processor assigns said primary water detection control to said second water detection sensor.

4. The steamer system of claim 2, wherein:
said processor is configured for enabling a shutdown clock time countdown when said processor relinquishes said primary water detection control from said first water detection sensor and assigns said primary water detection control to said second water detection sensor; and
said steamer system is configured to drain water from said water reservoir and power off when said shutdown clock time countdown expires.

5. The steamer system of claim 4, wherein:
the steamer system is configured to visually show said shutdown clock time countdown on said display when said shutdown clock time countdown is enabled.

6. The steamer system of claim 1, wherein:
said water boiling apparatus further comprises a third water detection sensor positioned higher within said water reservoir than said second water detection sensor and electrically connected to said processor.

7. The steamer system of claim 6, wherein:
said third water detection sensor is positioned within said water reservoir in close proximity to an overflow drain.

8. The steamer system of claim 7, further comprising:
an overflow housing connected to said overflow drain.

9. The steamer system of claim 6, wherein:
said steamer system is configured to drain water from said water reservoir and power off
when said third water detection sensor detects water.

10. The steamer system of claim 1, further comprising a graphical user interface (GUI) accessible via said display.

11. The steamer system of claim 1, further comprising a water recirculation system.

12. The steamer system of claim 1, further comprising a speaker connected to processor and configured for sounding audible alerts.

13. The steamer system of claim 1, further comprising:
a steam lid separating said cooking space from said water reservoir; and
said steam lid shaped to direct water toward a condensate drain.

14. A steam generation apparatus for a steamer comprising:
a water reservoir;
a processor connected to a power source;
a water inlet valve into said water reservoir fluidically connected to a water source and electrically connected to said processor;
a heater electrically connected to said processor and configured for heating water in said water reservoir to a boil;
a first water detection sensor positioned within said water reservoir and electrically connected to said processor;
a second water detection sensor positioned higher within said water reservoir than said first water detection sensor and electrically connected to said processor;
an overflow water detection sensor positioned higher within said water reservoir than said second water detection sensor and electrically connected to said processor; and
a drain system fluidically connected to said water reservoir and electrically connected to said processor;
wherein said steam generation apparatus is configured for producing steam when said water reservoir is filled with water and said heater heats water in said water reservoir to a boil.

15. The steam generation apparatus of claim 14, wherein:
said processor is configured for assigning primary water detection control to said first water detection sensor until said first water detection sensor is fouled; and
said processor is configured for relinquishing said primary water detection control from said first water detection sensor and assigning said primary water detection control to said second water detection sensor when said first water detection sensor is fouled until said second water detection sensor is fouled.

16. The steam generation apparatus of claim 15, wherein:
said steamer system is configured for increasing water level within said water reservoir to a level at or higher than the position of said second water detection sensor when said processor assigns said primary water detection control to said second water detection sensor.

17. The steam generation apparatus of claim 14, wherein said steamer system is configured to drain water from said water reservoir and power off when said overflow water detection sensor detects water.

18. A method of operating a steamer having a cooking space; a water boiling apparatus fluidically connected to the cooking space and electrically connected to a processor and a power source; the water boiling apparatus defining a water reservoir; a water inlet valve into the water reservoir fluidically connected to a water source and electrically connected to the processor; a heater electrically connected to the processor; the water boiling apparatus comprising a first water detection sensor positioned within said water reservoir and electrically connected to said processor, a second water detection sensor positioned higher within said water reservoir than said first water detection sensor and electrically connected to said processor, and a third water detection sensor positioned higher within said water reservoir than said second water detection sensor and electrically connected to said processor; and a drain system, the method comprising the steps of:
filling said water reservoir with water to a level at or higher than the position of said first water detection sensor and below the position of said second water detection sensor;
turning on said heater; and
said heater heating water in said water reservoir to a boil and providing steam to said cooking space.

19. The method of claim 18, further comprising the steps of:
when said first water detection sensor fouls, increasing water level within said water reservoir to a level at or higher than the position of said second water detection sensor and below the position of said third water detection sensor; and
enabling a shutdown clock time countdown.

20. The method of claim 19, further comprising the step of:
draining said water reservoir and powering off the steamer at the earlier of said shutdown clock time countdown expiring and said third water detection sensor detecting water.
